(19) United States
(12) Patent Application Publication
(10) Pub. No.: US 2017/0027260 A1
(43) Pub. Date: Feb. 2, 2017

(54) Pen Plant

(71) Applicant: Sandra Starr McCurdy, Las Vegas, NV (US)

(72) Inventor: Sandra Starr McCurdy, Las Vegas, NV (US)

(21) Appl. No.: 14/813,726

(22) Filed: Jul. 30, 2015

(51) Int. Cl. A41G 1/00; B43K 7/00; B43K 29/00

(52) U.S. Cl. CPC A41G 1/001; B43K 29/00; B43K 7/005

(57) ABSTRACT

An artificial house plant, hereby named ‘Pen Plant’, made from artificial wired plants wherein each individual shoot comprises of a ballpoint pen arranged in a pot or vase to realistically resemble a house plant. Floral tape may be used to create the illusion of the extension of the plants shoot or root. Pieces of the plant may be used to decorate vase or pot with, in some cases and as shown in FIG. 1-a, ribbon.

### CLAIM OF PRIORITY

This is a new patent application.

### DESCRIPTION

A useful, unique and classy way to decorate a home, business, hotel, or restaurant, while reducing pen replacement cost. Decorate a desk at home or office, make pens available for customers with staying power thus reducing overhead, resell in a flower shop, gift shop, place a small arrangement on a restaurant table, or offer guests a take home item in hotel rooms to increase profit. Made from artificial house plants, and ball point pens. A practical, low maintenance, decoration or gift.

### FIELD OF INVENTION

This invention relates generally to artificial house plant designs, and, more particularly, the invention relates to artificial house plant designs featuring a ball point pen incorporated into each shoot to create a realistic looking house plant with purpose.

### BACKGROUND OF INVENTION

### Description of the Prior Art

There is no prior art relating to the incorporation of a pen into an artificial house plant, but several designs for a faux flower incorporating a pen into its stem are present. Among these are:

U.S. Design Pat. No. 20150151564 to Katrina Jones shows floral arrangement featuring a ball point pen incorporated into the stem of some flowers to create a designated floral arrangement.

U.S. Design Pat. D328,310 to Shigeo Yoshinaga shows a retractable ball point pen having a flower attached to its distal end. [0006] U.S. Pat. No. 4,678,206 to Daniel P. Leahan describes a combination pen and note pad holder with the pad being formed in the shape of an open flower blossom and the pad adhered to a base member having the same flower shaped peripheral design.

U.S. Pat. No. 6,773,188 to Pia Tamaye describes flower pot pens wherein a pen holder in the form of a potted plant has a housing resembling a plant pot having a filler supporting potted plant material such as pebbles with a receptacle extending into the filler forming a cavity for the insertion therein of a pen and wherein the distal end of the pen has a decorative element such as a flower.

None of these references describe the present invention.

### SUMMARY OF INVENTION

It is an object of the present invention to provide an artificial house plant wherein the shoots of the plant incorporate a pen, and are placed into a vase or pot with pinto beans. Designs Vary; plant types, vases, pots, and number of pens used depends on design.

It is an object of the present invention to provide a useful, unique, an artificial, practical, low maintenance house plant featuring a ball point pen incorporated into each wired and flexible shoot, to create a realistic looking functional house plant with purpose.

### BRIEF DESCRIPTION OF DRAWINGS

FIG. 1 a, b, c, shows views of a two pen Ivy Pen Plant.

FIG. 2 shows a close up of an Ivy pen from FIG. 1-c.

FIG. 3 shows an 8 pen Ivy Pen Plant.

FIG. 4 shows a 12 pen Ivy Pen Plant.

FIG. 5 shows a Mini Pothos Pen Plant.

FIG. 6 shows a Coleus Pen Plant.

FIG. 7 shows a Pictum Fern Pen Plant. [0018] FIG. 8 shows a Coleus Pen Plant.

FIG. 9 shows a Sygonium Pen Plant. [0020] FIG. 10 shows a Sinoja Pen Plant.

FIG. 11 shows a Mini Birds Nest Pen Plant, design 1.

FIG. 12 shows a Mini Birds Nest Pen Plant, design 2.

FIG. 13 a-f shows Combination Pen Plant designs using various artificial plant species.

### DETAILED DESCRIPTION OF PREFERRED EMBODIMENTS

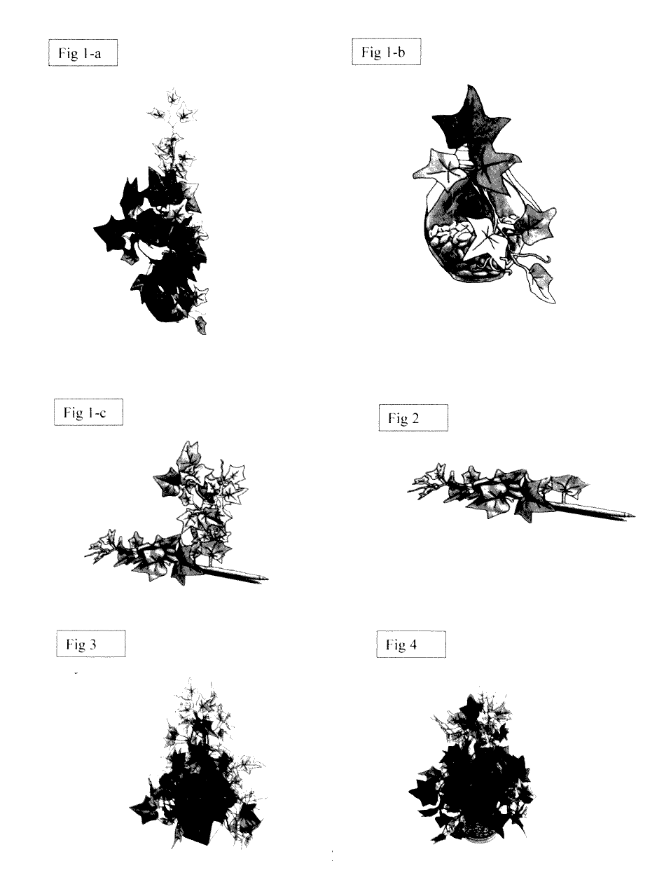

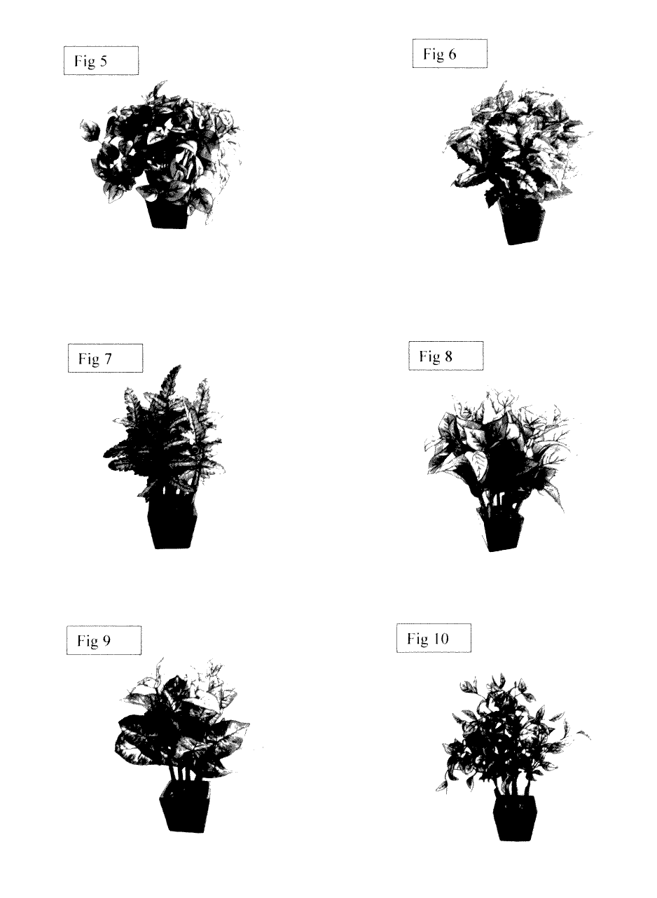

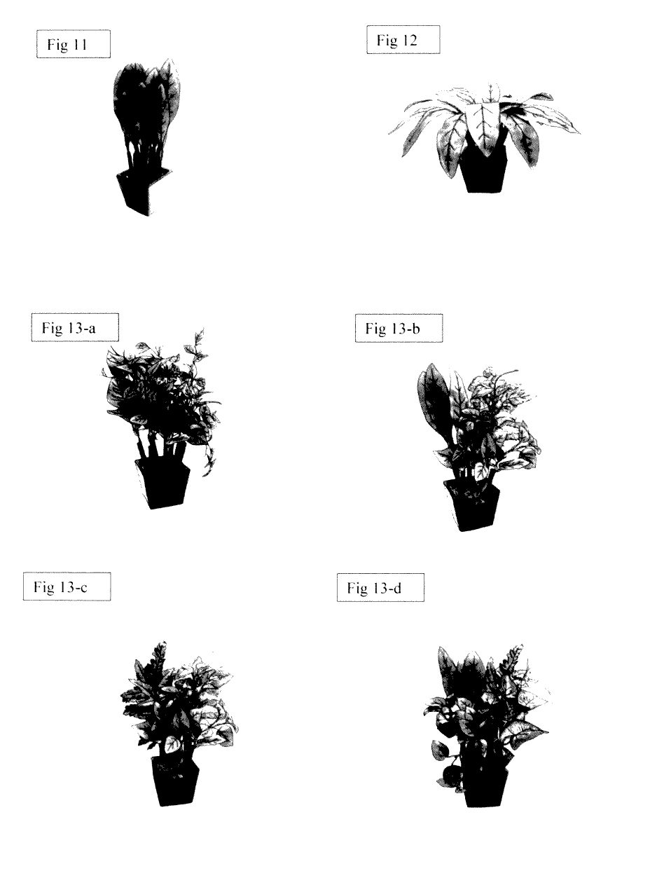

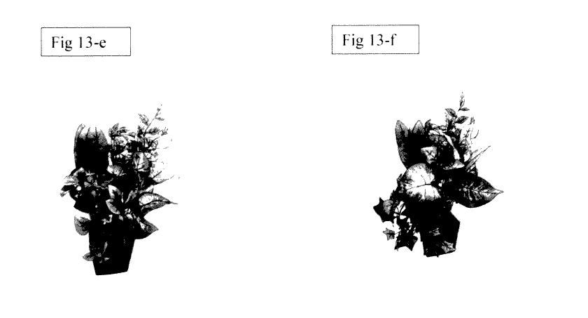

As illustrated in FIGS. 1-13, the present invention is an artificial house ‘Pen Plant’ providing a specially designed line of artificial plants for use in creating any number of useful, and realistic house plants featuring a ball point pen incorporated into each shoot.

The ‘Pen Plant’ invention can be produced in a variety of house plants in which some are pictured here. The plants are wired so that they can be easily manipulated to create a variety of designs. Each plant design is realistic in size and color so the final product looks like a real plant, but each shoot comprised of a ball point pen can be utilized as a writing instrument. The Pen Plant can be sold to many business establishments, and to the general consumer.

Use of the artificial house ‘Pen Plant’ is simple, straight forward, useful and practical. Users simply purchase various size pen plants for the number of pens that suit their needs. For instance, a restaurant may order a two pen plant to display on each of their tables with a notepad with their restaurants website to offer for resale. A hotel may find a larger display useful at their check-in area for customers to use. They may place a variety of sizes in their gift shop for resale, or place one in each room with the option to buy it for additional profit. Small offices may purchase them for their employee's desks to reduce overhead. Alternately, companies may display them in various places throughout their establishment to reduce overhead, and add to their current décor. As needed, the user removes individual shoots from the plant, utilizing the writing instrument implemented into it to record information, then returning it to the plant after use.

The ‘Pen Plant’ offers users a number of significant benefits and advantages. Foremost, the Pen Plant provides users a useful, practical, and beautiful decorative tool to use in their home or office. Elegantly designed to add a touch of class to any motif, the beautifully crafted plants incorporate a writing instrument, a ball point pen, to each shoot for quick access and easy arrangement.

Users will enjoy purchasing their favorite plant from the Pen Plant line to create a unique addition to any room of their home or office to have a writing instrument at hand. Well suited for business use; Pen Plants help to reduce overhead by providing customers a writing instrument with staying power, increase their profits and add elegance and uniqueness to their current motif while reducing theft.

The ‘Pen Plant’ is fun to use; users of all ages will enjoy writing with this these practical pens while giving them the feeling that they have just experienced something special. Everyone will want one of these beautiful displays.

Rather than companies wasting their money on imprinted pens with promotional advertising that never get read, the ‘Pen Plant’ will increase word of mouth, and have your customers talking about your establishment in no time. The ‘Pen Plant’ can be offered on a business website, sold in a gift shop or floral shop, displays and sold in hotel rooms, and restaurants. When the ink is depleted, individual replacements are available.

The ‘Pen Plant’ offers users a beautiful artificial plant with the convenience of a writing instrument in one simple to use product. Produced in a variety of plant types and designs, these beautiful ‘Pen Plants’ appeal to a wide variety of users.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art.

Moreover, the invention as disclosed herein may be suitably practiced in the absence of the specific elements which are disclosed herein.

1. An artificial house plant hereby named ‘Pen Plant’, made from artificial wired plants wherein each individual shoot comprises of a ballpoint pen.

2. The ‘Pen Plant’ made of artificial wired plants of claim 1, wherein the wired shoot of each comprising of a pen, thus enabling the user to easily manipulate the plant shoot to bend the greenery for a unique look or too quickly access the pen for domestic or business use.

3. An artificial house plant with individual shoots comprising of a pen.
